(19) United States
(12) Patent Application Publication
(10) Pub. No.: US 2024/0330172 A1
(43) Pub. Date: Oct. 3, 2024

(54) Intelligent Allocation of Read and Write Buffers in Memory Sub-Systems

(71) Applicant: Micron Technology, Inc., Boise, ID (US)

(72) Inventors: Saideep Tiku, Folsom, CA (US); Poorna Kale, Folsom, CA (US)

(21) Appl. No.: 18/593,806

(22) Filed: Mar. 1, 2024

Related U.S. Application Data
(60) Provisional application No. 63/493,503, filed on Mar. 31, 2023.

(51) Int. Cl. G06F 12/02

(52) U.S. Cl. CPC G06F 12/023

(57) ABSTRACT

A memory sub-system operable to dynamically adjusts its allocation of a read buffer and a write buffer. For example, after the read buffer and the write buffer are allocated to have a first ratio between their capacities, data communicated for read commands is buffered in the read buffer; and data communicated for write commands is buffered in the write buffer. Statistics of read commands and write commands received in the memory sub-system during a first time period can be tracked to determine a current application context of operating the memory sub-system. A second ratio is determined via a predictive model from the current application context. The allocation of the read buffer and the write buffer is adjusted according to the second ratio for operating the memory sub-system during a second time period following the first time period.

### RELATED APPLICATIONS

The present application claims priority to Prov. U.S. Pat. App. Ser. No. 63/493,503 filed Mar. 31, 2023, the entire disclosures of which application are hereby incorporated herein by reference.

### TECHNICAL FIELD

At least some embodiments disclosed herein relate to memory systems in general, and more particularly, but not limited to data buffers in memory systems.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system that includes a memory sub-system in accordance with some embodiments of the present disclosure.

FIG. 2 illustrates the adjustment of a read buffer and a write buffer in a memory sub-system according to one embodiment.

FIG. 3 shows the determination of an optimized ratio for the allocation of a read buffer and a write buffer in a memory sub-system according to one embodiment.

FIG. 4 illustrates the training of an artificial neural network model to predict optimized ratios for the allocation of a read buffer and a write buffer in a memory sub-system according to one embodiment.

FIG. 5 illustrates the use of an artificial neural network model to adjust the allocation of a read buffer and a write buffer in a memory sub-system according to one embodiment.

FIG. 6 illustrates the generation of a lookup table to adjust the allocation of a read buffer and a write buffer in a memory sub-system according to one embodiment.

FIG. 7 and FIG. 8 show examples of universal flash storage devices having buffer managers configured according to some embodiments.

FIG. 9 shows a method of buffer management according to one embodiment.

FIG. 10 is a block diagram of an example computer system in which embodiments of the present disclosure can operate.

### DETAILED DESCRIPTION

At least some aspects of the present disclosure are directed to intelligent buffer allocations in a memory sub-system for improved performance.

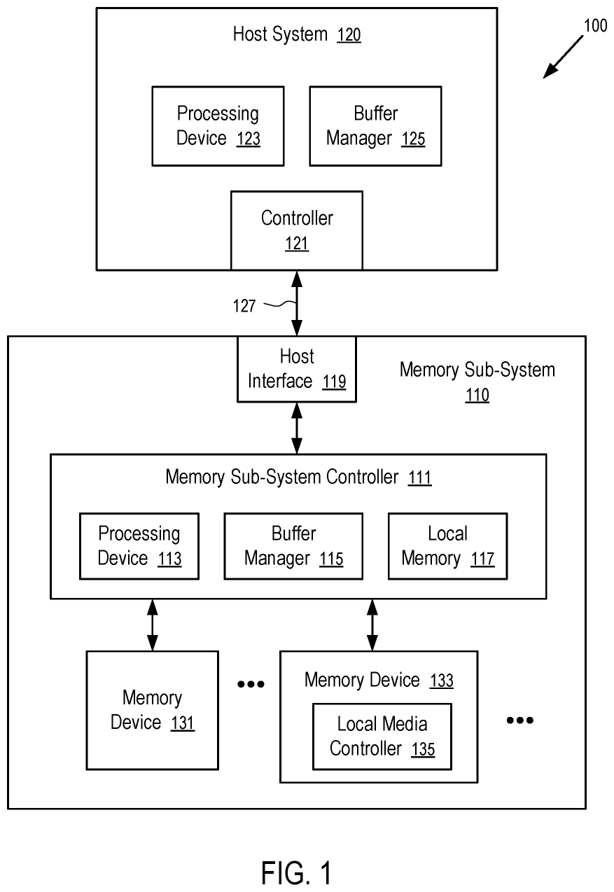

In general, a memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data; and the host system can provide data to be stored at the memory sub-system and can request data to be retrieved from the memory sub-system.

A memory sub-system can have an input output buffer for communications with a host system. The input output buffer can be split into a read buffer allocated for read operations requested by the host system and a write buffer allocated for write operations requested by the host system. The performance of the memory sub-system in processing read requests from the host system can degrade when the capacity of the read buffer is insufficient to meet the workloads of read operations. Similarly, the performance of the memory sub-system in processing write requests from the host system can degrade when the capacity of the write buffer is insufficient to meet the workloads of write operations.

The workloads of read operations and write operations of a memory sub-system can change. A static memory allocation for the read buffer and the write buffer can impact the performance of the memory sub-system, e.g., when the workload ratio between read operations and write operations deviates from a target ratio based on which the static memory allocation is optimal.

At least some aspects of the present disclosure address the above and other deficiencies by configuring a logic circuit in the memory sub-system to intelligently split the input output buffer for read operations and write operations.

For example, the logic circuit can be configured in the memory sub-system to track the statistics of read commands and write commands received via a host interface in a past period of time. A buffer split for read and write operations according to the ratio of read commands and write commands received from the host system in the past period can be optimal for the workload in the past period. However, since the workloads of the memory sub-system can change, what is optimal for the past period may not be optimal for the subsequent period of time.

A predictive model can be trained to predict an optimized buffer split for read operations and write operations in the next period of time based on an application context of the memory sub-system.

For example, when the memory sub-system is used in an application (e.g., automotive storage, infotainment, automotive operating system, accessing central storage), the changes of workloads of the memory sub-system can have a pattern that is dependent on the application context. During a simulated, emulated, test, or initial run of the application, different ways to split the buffer memory for read operations and write operations can be tried for various workload conditions to measure the performance levels of the memory sub-system under varying application contexts. A preferred or optimized ratio for splitting the buffer for read and write operations in a next period of time can be determined for a respective current application context. The predictive model can be trained via machine learning to predict a preferred or optimized split for a given application context. The trained predictive model can be subsequently used to determine the desirable split of the buffer memory for read operations and write operations under varying application contexts.

An application context can be represented by the workload condition tracked by the logic circuit configured in the memory sub-system, such as the statistics of read commands and write commands received in the memory sub-system from the host system in one or more past periods of time. Optionally, the application context can further include information relevant to workloads and provided by the host system, such as the identification of routines or applications that cause the host system to access the memory sub-system, milestones of the execution of the routines or applications, lapsed times from the milestones, etc.

Optionally, a set of application contexts can be pre-selected as candidates; and the predictive model is used to generate a lookup table of buffer memory split ratios for the respective candidate application contexts. A current application context can be mapped to (e.g., via rounding up to) a closest one of the candidate application contexts. A split ratio looked up from the lookup table for the closest candidate context can be used to split the buffer memory for read operations and write operations.

For example, the logic circuit configured in the memory sub-system can track the ratio of read commands and write commands received in a past period of time, round the ratio up to a closest candidate command ratio in the lookup table, and look up a buffer split ratio from the lookup table based on the closest candidate command ratio. The buffer split ratio obtained from the lookup table can then be used to adjust the read buffer and the write buffer of the memory sub-system for the next period of time.

Optionally, the logic circuit can be configured to avoid large changes in buffer allocation. For example, the possible range of buffer allocation ratios can be limited to avoid unrealistic buffer sizes. For example, the allowable range of change to buffer allocations can be limited to the vicinity of the current buffer configuration to avoid rapid changes in buffer allocation. Therefore, based on the ratio between read operations and write operations tracked by the logic circuit in the past period of time, a reallocation preset can be chosen by the logic circuit to adjust the sizes of the read buffer and the write buffer.

Desirable choices/matches between the ratios of read and write operations tracked by the logic circuit and ratios of read and write buffers can be established via collecting traces of the target application. Various buffer split ratios can be tried based on the collected traces in a simulated/emulated environment to identify the best choices of buffer split ratios to generate training data. A machine learning model (e.g., an artificial neural network) can be trained using the training data to fit the relation between the ratios of tracked read write operations and the best choices of buffer splits obtained from the simulations or emulations. The machine learning model can be implemented in the memory sub-system to control the adaptive customization of the configuration of read and write buffers. Alternatively, possible ranges of ratios of tracked read write operations can be fed into the machine learning model to output buffer ratio splits. Such a table showing the tracked read write operation ratios and their respective desirable buffer split ratios can be then loaded as part of the firmware of the memory-subsystem and used to control read write buffer configurations post deployment.

FIG. 1 illustrates an example computing system 100 that includes a memory sub-system 110 in accordance with some embodiments of the present disclosure. The memory sub-system 110 can include media, such as one or more volatile memory devices (e.g., memory device 131), one or more non-volatile memory devices (e.g., memory device 133), or a combination of such.

In general, a memory sub-system 110 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 120 that is coupled to one or more memory sub-systems 110. FIG. 1 illustrates one example of a host system 120 coupled to one memory sub-system 110. As used herein, “coupled to” or “coupled with” generally refers to a connection 127 between components, which can be an indirect communicative connection or direct communicative connection (e.g., without intervening components), whether wired or wireless, including connections such as electrical, optical, magnetic, etc.

For example, the host system 120 can include a processor chipset (e.g., processing device 123) and a software stack executed by the processor chipset. The processor chipset can include one or more cores, one or more caches, a memory controller (e.g., controller 121) (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface 119. Examples of a physical host interface include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI) interface, a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface can be used to transmit data between the host system 120 and the memory sub-system 110. The host system 120 can further utilize an NVM express (NVMe) interface to access components (e.g., memory devices 133) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The processing device 123 of the host system 120 can be, for example, a microprocessor, a central processing unit (CPU), a processing core of a processor, an execution unit, etc. In some instances, the controller 121 can be referred to as a memory controller, a memory management unit, and/or an initiator. In one example, the controller 121 controls the communications over a bus coupled between the host system 120 and the memory sub-system 110. In general, the controller 121 can send commands or requests to the memory sub-system 110 for desired access to memory devices 131, 133. The controller 121 can further include interface circuitry to communicate with the memory sub-system 110. The interface circuitry can convert responses received from the memory sub-system 110 into information for the host system 120.

The controller 121 of the host system 120 can communicate with the controller 111 of the memory sub-system 110 to perform operations such as reading data, writing data, or erasing data at the memory devices 131, 133 and other such operations. In some instances, the controller 121 is integrated within the same package of the processing device 123. In other instances, the controller 121 is separate from the package of the processing device 123. The controller 121 and/or the processing device 123 can include hardware such as one or more integrated circuits (ICs) and/or discrete components, a buffer memory, a cache memory, or a combination thereof. The controller 121 and/or the processing device 123 can be a microcontroller, special-purpose logic circuitry (e.g., a field programmable gate array (FPGA), an application specific integrated circuit (ASIC), etc.), or another suitable processor.

The memory devices 131, 133 can include any combination of the different types of non-volatile memory components and/or volatile memory components. The volatile memory devices (e.g., memory device 131) can be, but are not limited to, random-access memory (RAM), such as dynamic random-access memory (DRAM) and synchronous dynamic random-access memory (SDRAM).

Some examples of non-volatile memory components include a negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 133 can include one or more arrays of memory cells. One type of memory cell, for example, single level cells (SLCs) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 133 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells of the memory devices 133 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 133 can be based on any other type of non-volatile memory, such as read-only memory (ROM), phase change memory (PCM), self-selecting memory, other chalcogenide based memories, ferroelectric transistor random-access memory (FeTRAM), ferroelectric random-access memory (FeRAM), magneto random-access memory (MRAM), spin transfer torque (STT)-MRAM, conductive bridging RAM (CBRAM), resistive random-access memory (RRAM), Oxide based RRAM (OxRAM), negative-or (NOR) flash memory, and electrically erasable programmable read-only memory (EEPROM).

A memory sub-system controller 111 (or controller 111 for simplicity) can communicate with the memory devices 133 to perform operations such as reading data, writing data, or erasing data at the memory devices 133 and other such operations (e.g., in response to commands scheduled on a command bus by controller 121). The controller 111 can include hardware such as one or more integrated circuits (ICs) and/or discrete components, a buffer memory, or a combination thereof. The hardware can include digital circuitry with dedicated (i.e., hard-coded) logic to perform the operations described herein. The controller 111 can be a microcontroller, special-purpose logic circuitry (e.g., a field programmable gate array (FPGA), an application specific integrated circuit (ASIC), etc.), or another suitable processor.

The controller 111 can include a processing device 113 (processor) configured to execute instructions stored in a local memory 117. In the illustrated example, the local memory 117 of the controller 111 includes an embedded memory configured to store instructions for performing various processes, operations, logic flows, and routines that control operation of the memory sub-system 110, including handling communications between the memory sub-system 110 and the host system 120.

In some embodiments, the local memory 117 can include memory registers storing memory pointers, fetched data, etc. The local memory 117 can also include read-only memory (ROM) for storing micro-code. While the example memory sub-system 110 in FIG. 1 has been illustrated as including the controller 111, in another embodiment of the present disclosure, a memory sub-system 110 does not include a controller 111, and can instead rely upon external control (e.g., provided by an external host, or by a processor or controller separate from the memory sub-system).

In general, the controller 111 can receive commands or operations from the host system 120 and can convert the commands or operations into instructions or appropriate commands to achieve the desired access to the memory devices 133. The controller 111 can be responsible for other operations such as wear leveling operations, garbage collection operations, error detection and error-correcting code (ECC) operations, encryption operations, caching operations, and address translations between a logical address (e.g., logical block addressing (LBA) addresses, namespace) and a physical address (e.g., physical block address) that are associated with the memory devices 133. The controller 111 can further include host interface circuitry to communicate with the host system 120 via the physical host interface. The host interface circuitry can convert the commands received from the host system into command instructions to access the memory devices 133 as well as convert responses associated with the memory devices 133 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the controller 111 and decode the address to access the memory devices 133.

In some embodiments, the memory devices 133 include local media controllers 135 that operate in conjunction with the memory sub-system controller 111 to execute operations on one or more memory cells of the memory devices 133. An external controller (e.g., memory sub-system controller 111) can externally manage the memory device 133 (e.g., perform media management operations on the memory device 133). In some embodiments, a memory device 133 is a managed memory device, which is a raw memory device combined with a local controller (e.g., local media controller 135) for media management within the same memory device package. An example of a managed memory device is a managed NAND (MNAND) device.

The computing system 100 includes a buffer manager configured to dynamically adjust the configuration of a read buffer and a write buffer in the local memory 117. For example, a buffer manager 115 in the memory sub-system 110 can control the read write buffer configuration in the local memory 117. Optionally, a buffer manager 125 in the host system 120 can be configured to instruct the buffer manager 115 in the memory sub-system 110 to adjust its read write buffer configuration. In some embodiments, the controller 111 in the memory sub-system 110 includes at least a portion of the buffer manager 115. In other embodiments, or in combination, the controller 121 and/or the processing device 123 in the host system 120 includes at least a portion of a buffer manager 125 that is configured to perform the operations in managing the read and write buffers configured in the local memory 117. For example, the controller 111, the controller 121, and/or the processing device 123 can include logic circuitry implementing operations of the buffer manager 115 and/or the buffer manager 125. For example, the controller 111, or the processing device 123 (processor) of the host system 120, can be configured to execute instructions stored in memory for performing the operations of the buffer manager 115 and/or and the buffer manager 125 described herein. In some embodiments, the buffer manager 115 is implemented in an integrated circuit chip disposed in the memory sub-system 110. In other embodiments, the buffer manager 125 is part of an operating system of the host system 120, a device driver, or an application.

For example, the buffer manager 115 and/or the buffer manager 125 can track the activities about an application running in the host system 120 that writes data into and reads data from the memory sub-system 110. Based on the tracked activities, the buffer manager 115 and/or the buffer manager 125 can determine best performing read and write buffer configurations for some application contexts (e.g., via trying different buffer configurations, or via simulations or emulations of the tracked activities). The best performing read and write buffer configurations for the application contexts can be as a training dataset to train a predictive model (e.g., an artificial neural network). The predictive model can then be used in the buffer manager 115 and/or the buffer manager 125 to adapt the read and write buffer configuration in the local memory 117 in view of the current application context. Optionally, the predictive model (e.g., an artificial neural network) can be converted into a form of a lookup table for used in the buffer manager 115 and/or the buffer manager 125.

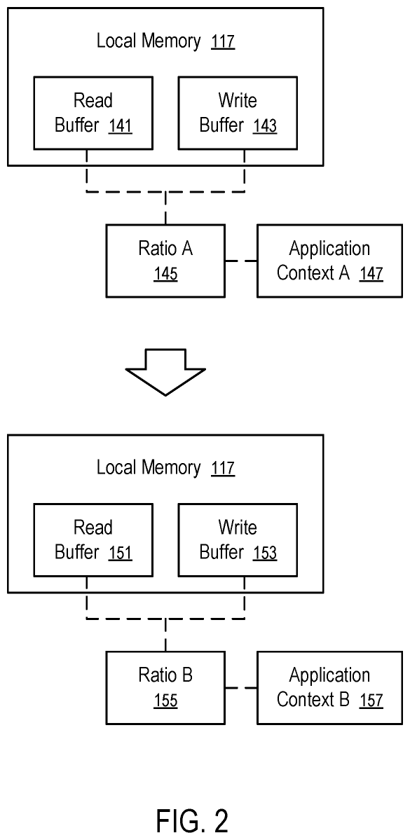

FIG. 2 illustrates the adjustment of a read buffer and a write buffer in a memory sub-system according to one embodiment. For example, the technique of FIG. 2 can be implemented in the computing system 100 of FIG. 1.

In FIG. 2, a read buffer 141 and a write buffer 143 are configured in a local memory 117 of a memory sub-system 110 (e.g., as in FIG. 1) for communications with a host system 120 (e.g., as in FIG. 1).

The read buffer 141 can be used to buffer data retrieved from memory devices (e.g., 131, 133) of the memory sub-system 110 in response to read commands from the host system 120, prior to the retrieve data being communicated across the connection 127 to the host system 120. Read commands received from the host system 120 over the connection 127 can also be buffered in the read buffer 141, prior to the execution of the read commands in the memory sub-system 110.

The write buffer 143 can be used to buffer write commands and data received from the host system 120 prior to the memory sub-system 110 executing the write commands to write the data into the memory devices (e.g., 131, 133) of the memory sub-system 110.

When a buffer manager (e.g., 115 and/or 125) of the computing system 100 determines that the memory sub-system 110 is in a first application context 147, the buffer manager can configure the read buffer 141 and the write buffer 143 according to a first ratio 145 using a fixed, predetermined amount of the local memory 117.

When the buffer manager (e.g., 115 and/or 125) of the computing system 100 determines that the memory sub-system 110 is in a second application context 157, the buffer manager can configure the read buffer 151 and the write buffer 153 according to a second ratio 155 using the same fixed, predetermined amount of the local memory 117.

The application contexts (e.g., 147, 157) can be based at least in part on the statistics of read commands and write commands transmitted from the host system 120 to the memory sub-system 110 over the connection 127 in a most recent period of time.

For example, the statistics can include an average ratio between read commands and write commands in the most recent period of time, or a history of changes of the read write command ratio over several most recent periods each having a same predetermined time interval.

For example, the statistics can include the counts of pending read and write commands in the local memory 117.

Optionally, the application contexts (e.g., 147, 157) can include other information indicative of workloads of the memory sub-system 110 in the next period of time, such as an identification of an application running in the host system 120, a milestone of the execution of the application, a lapse time from the milestone, etc.

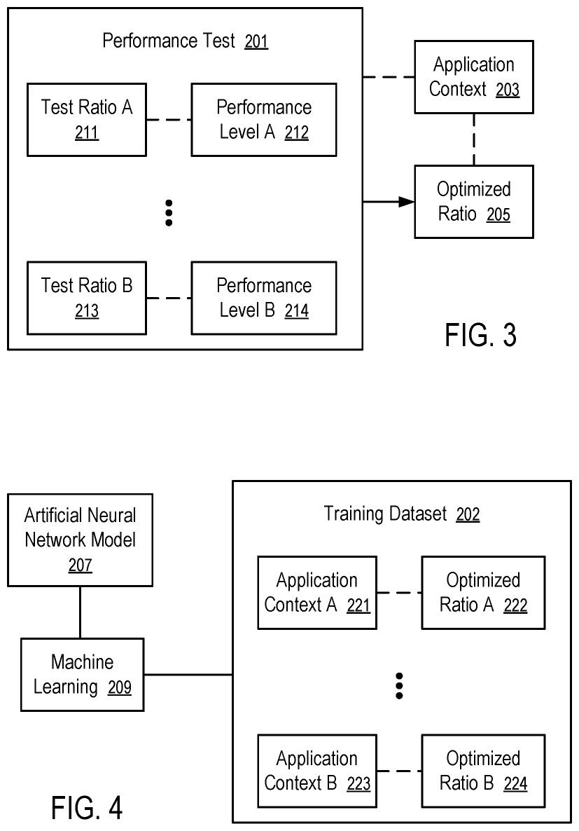

The determination of the ratios (e.g., 145, 155) from the application contexts (e.g., 147, 157) can be based on a predictive model (e.g., an artificial neural network). Such a predictive model can be established using the techniques of FIG. 3 to FIG. 6.

FIG. 3 shows the determination of an optimized ratio for the allocation of a read buffer and a write buffer in a memory sub-system according to one embodiment.

In FIG. 3, an optimized ratio 205 for splitting a local memory 117 into a read buffer and a write buffer can be obtained from a performance test 201.

For example, when the computing system 100 is running in an application context 203, the read write workloads of the memory sub-system 110 can be tracked for the next time period. The workloads can include the pending read write commands in the local memory 117 and the possible variations of read write commands to be sent from the host system 120 to the memory sub-system 110.

The processing of the read write workloads by the memory sub-system 110 with different ratios 211, . . . , 213 of splitting the local memory 117 can be tested to obtain their corresponding performance levels 212, . . . , 214.

For example, a simulation or emulation of the memory sub-system 110 processing the read write workloads can be performed (e.g., in the host system 120 using the buffer manager 125, or in another computer). In the simulation or emulation, the performance level (e.g., 212) of the memory sub-system 110 in processing the read write workloads for the application context in the next time period can be measured for each test ratio (e.g., 211) used to split the local memory 117.

Alternatively, the performance test 201 can be based on using different test ratios 211, . . . , 213 in the operations of the computing system during a training data collection period for the application context 203 to measure the actual performance levels 212, . . . , 214 of the memory sub-system 110 of changing to the test ratios 211, . . . , 213 for the next time period.

From the performance test 201, an optimized ratio 205 can be selected for the application context 203. Subsequently, when the memory sub-system 110 is operating in the application context 203, the buffer manager (e.g., 115 and/or 125) can adjust the split of the local memory 117 according to the optimized ratio 205.

Optionally, a set of optimized ratios (e.g., 205) can be determined for a set of application contexts (e.g., 203) to generate a train dataset for a predictive model, as in FIG. 4.

FIG. 4 illustrates the training of an artificial neural network model to predict optimized ratios for the allocation of a read buffer and a write buffer in a memory sub-system according to one embodiment.

In FIG. 4, a training dataset 202 includes a plurality of optimized ratios 222, . . . , 224 determined for a plurality of application contexts 221, . . . , 223 respectively. For example, the optimized ratio (e.g., 222) of each application context (e.g., 221) in the training dataset 202 can be obtained using the technique of FIG. 3.

An artificial neural network model 207 can be trained using a technique of machine learning 209 based on the training dataset 202. The machine learning 209 can be configured to adjust the parameters in the artificial neural network model 207 to reduce or minimize the differences between a ratio predicted by the model 207 for an application context (e.g., 221 or 223) in the training dataset 202 and the corresponding optimized ratio (e.g., 222 or 224) in the training dataset 202.

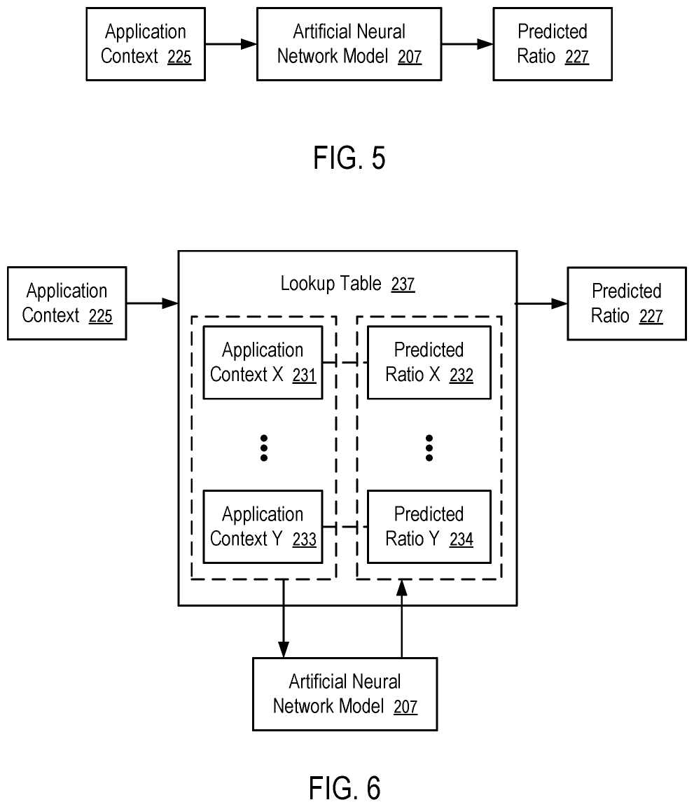

After the training using the training dataset 202 and the technique of machine learning 209, the artificial neural network model 207 can be used to predict an optimized ratio for a given application context 221 in a way similar to the pattern in the training dataset 202. The predicted ratio generated by the model 207 can be used to control the splitting of the local memory 117 into a read buffer (e.g., 141 or 151) and a write buffer (e.g., 143 or 153), as in FIG. 5.

FIG. 5 illustrates the use of an artificial neural network model to adjust the allocation of a read buffer and a write buffer in a memory sub-system according to one embodiment.

For example, when the buffer manager (e.g., 115 and/or 125) determines that the memory sub-system 110 is operating at an application context 225, the buffer manager can provide the application context 225 as an input to the artificial neural network model 207 (e.g., as training using the technique of FIG. 4) to generate a predicted ratio 227. Since the artificial neural network model 207 has been trained using a training dataset, the likelihood of the predicted ratio 227 being optimal or close to optimal is high. Thus, if the predicted ratio 227 is different from the current ratio of splitting the local memory 117, the memory sub-system 110 can adjust the splitting the local memory 117 according to the predicted ratio 227.

Optionally, the predictions of the artificial neural network model 207 can be tabulated for a set of pre-determined application contexts; and the application context 225 can be rounded up to a closest pre-determined application contexts to look up a predicted ratio, as in FIG. 6.

FIG. 6 illustrates the generation of a lookup table to adjust the allocation of a read buffer and a write buffer in a memory sub-system according to one embodiment.

In FIG. 6, a set of possible application contexts 231, . . . , 223 are used as inputs to an artificial neural network model 207 (e.g., having been trained as in FIG. 4). The predicted ratios 232, . . . , 234 generated by the artificial neural network model 207 for the respective application contexts 231, . . . , 233 can be listed in a lookup table 237. The lookup table 237 can be used as a replacement of the artificial neural network model 207 in the buffer manager (e.g., 115 and/or 125) of the computing system 100.

For example, when the buffer manager (e.g., 115 and/or 125) of the computing system 100 determines that the memory sub-system 110 is currently operating in the application context 225, the buffer manager can convert the application context 225 to a closest application context (e.g., 231 or 233) in the look up table. The predicted ratio (e.g., 232 or 234) looked up from the table 237 for the closest application context (e.g., 231 or 233) can be used as the predicted ratio 227 for the application context 225.

In some implementations, the number of possible application context 231, . . . , 233 is small. Thus, the lookup table 237 can be generated from performance tests (e.g., 201 in FIG. 3) directly in a way similar to the generation of training dataset 202 in FIG. 4. The operations of training an artificial neural network model 207 using machine learning 209, and the operations to tabulate results from a trained artificial neural network model 207 can be skipped.

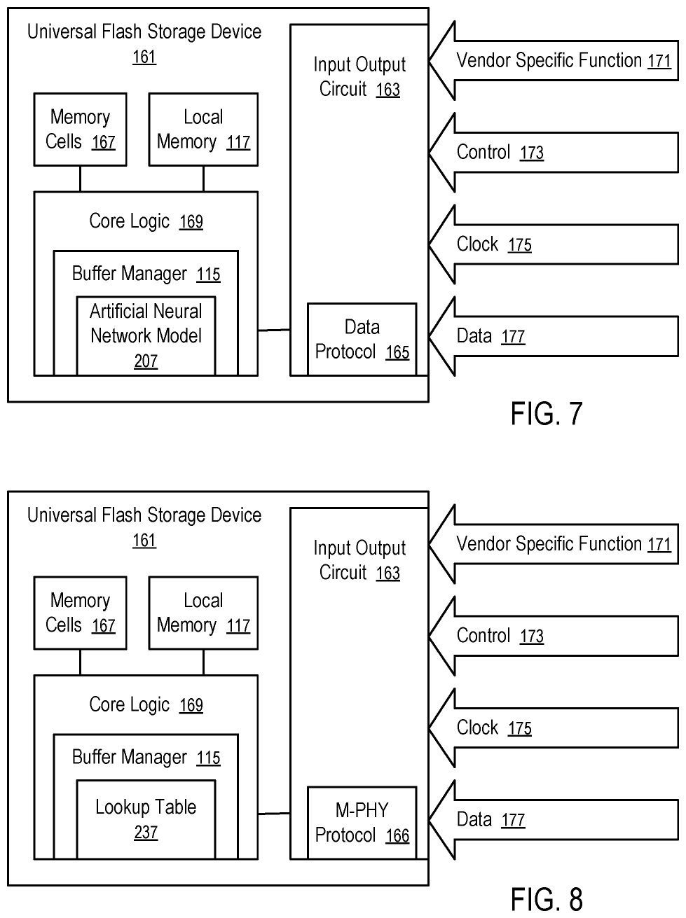

In some implementations, the memory sub-system 110 is configured as a universal flash storage (UFS) device, as in FIG. 7 and FIG. 8,

FIG. 7 and FIG. 8 show examples of universal flash storage devices having buffer managers 115 configured according to some embodiments.

In FIG. 7 and FIG. 8, a universal flash storage device 161 has an input output circuit 163 configured as a host interface 119 for communication over a connection (e.g., 127) to a host system 120 (e.g., in FIG. 1).

The input output circuit 163 can include pins or contacts to signal lines, such as control 173, clock 175, data 177, and vendor specific function 171. The input output circuit 163 can implement communication protocols for the data 177, clock 175, and control 173 according to a standard for universal flash storage (UFS).

For example, the input output circuit 163 can implement a physical layer of protocol 165 for data communication over a data line. For example, the data protocol 165 can be a M-PHY protocol 166 (e.g., in FIG. 8) that allows a scalable variety of signal speeds per lane of differential signal wires.

The universal flash storage device 161 can have a core logic 169 configured as a processing device of a memory sub-system 110. A buffer manager 115 can be implemented in the core logic 169 via logic circuit and/or firmware.

The universal flash storage device 161 has a local memory 117 usable as a read buffer (e.g., 141 or 151) and a write buffer (e.g., 143 or 153) as in FIG. 2. The buffer manager 115 can determine the application context in which the universal flash storage device 161 is currently operating based on read and write commands received via the input output circuits 163. Optionally, the vendor specific function 171 can be used by the host system 120 to provide additional data about the application context, such as an identification of an application running in the host system 120, a milestone of the execution of the application, etc.

The universal flash storage device 161 has memory cells 167. The core logic 169 can execute the read and write commands buffered in the local memory 117 to write data from the write buffer (e.g., 143 or 153) into the memory cells 167 and to read data from the memory cells 167 into the read buffer (e.g., 141 or 151).

In FIG. 7, the buffer manager 115 is configured to use an artificial neural network model 207 (e.g., as trained in the FIG. 4). For a current application context 225, the buffer manager 115 can use the artificial neural network model 207 to predict a ratio 227 for the splitting of the local memory 117 into a read buffer (e.g., 141 or 151) and a write buffer (e.g., 143 or 153), as in FIG. 5

In FIG. 8, the buffer manager 115 is configured to use a lookup table 237 (e.g., as tabulated from an artificial neural network model 207 as in the FIG. 5, or generated directly from performance tests as in FIG. 3). For a current application context 225, the buffer manager 115 can use the lookup table to predict a ratio 227 for the splitting of the local memory 117 into a read buffer (e.g., 141 or 151) and a write buffer (e.g., 143 or 153), as in FIG. 6.

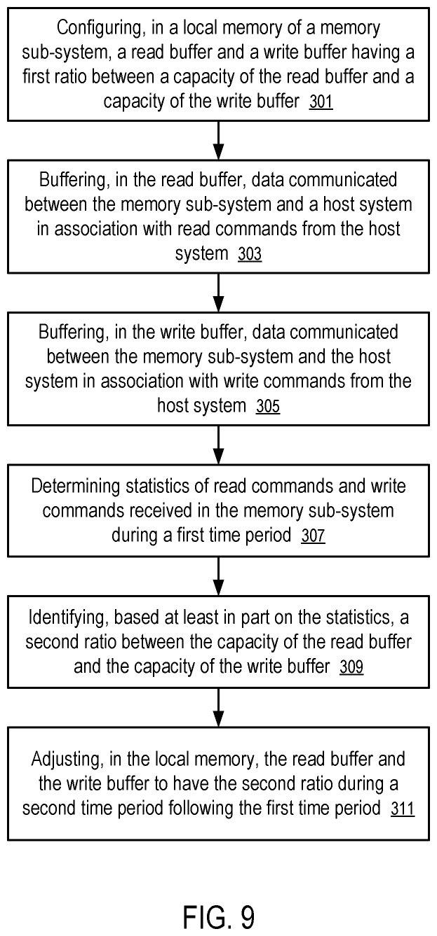

FIG. 9 shows a method of buffer management according to one embodiment.

For example, the method of FIG. 9 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 9 is performed at least in part by the buffer manager 115 and/or the buffer manager 125 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 9 can be implemented in the computing system 100 of FIG. 1. the computing system 100 includes a memory sub-system 110 having memory cells (e.g., 167 in memory devices 131 or 133 configured on an integrated circuit die). The memory cells 167 can provide a storage capacity of the memory sub-system 110 over a host interface 119 (e.g., input output circuit 163) over a connection 127 to a host system 120. The memory sub-system 110 can have a logic circuit (e.g., processing device 113, core logic 169) configured to process read commands and write commands received from the host system 120 in the host interface 119. The memory sub-system 110 has a local memory 117 configured between the host interface 119 and the logic circuit to buffer data communicated between the memory sub-system 110 and the host system 120 in association with the read commands and the write commands.

For example, the memory sub-system 110 can be a universal flash storage (UFS) device 161; and the host interface 119 includes an input output circuit 163 configured to perform communications with a host system 120 according to a specification for universal flash storage (UFS). For example, the data communications in the input output circuit 163 can be in accordance with an M-PHY protocol 166.

At block 301, the method includes configuring, in a local memory 117 of a memory sub-system 110, a read buffer 141 and a write buffer 143 having a first ratio 145 between a capacity of the read buffer 141 and a capacity of the write buffer 143.

At block 303, the method includes buffering, in the read buffer 141, data communicated between the memory sub-system 110 and a host system 120 in association with read commands from the host system 120.

For example, the read buffer 141 can be used to buffer the read commands received from the host system 120 before the execution of the read commands by the memory sub-system 110.

For example, the read buffer 141 can be used to buffer the data retrieved from the memory cells 167 during the execution of the read commands before the transmission of the retrieved data over the connection 127 to the host system 120.

At block 305, the method includes buffering, in the write buffer 143, data communicated between the memory sub-system 110 and the host system 120 in association with write commands from the host system 120.

For example, the write buffer 143 can be used to buffer the write commands received from the host system 120 and the data to be written into the memory cells 167 before the execution of the write commands by the memory sub-system 110.

At block 307, the method includes determining statistics of read commands and write commands received in the memory sub-system 110 during a first time period.

For example, after the read buffer 141 and the write buffer 143 are configured according to the first ratio 145 according to an application context 147, the memory sub-system 110 can operate for the first period of time. During the first period of time, the application context in which the memory sub-system 110 is operated or used by the host system 120 can change from the prior application context 147 to a new application context 157.

For example, the application context 157 can be configured to be identified based at least in part on the statistics of read commands and write commands, such as a count of read commands received in the first period of time, a count of write commands received in the second period of time, a ratio between the count of the read commands and the count of the write commands.

Optionally, the application context 157 can be further configured to be identified at least in part on the information provided by the host system 120, such as an identification of an application running in the host system 120 to access the memory sub-system 110, a milestone of execution of the application, a lapse time from the milestone, etc.

For example, at least a portion of the application context 157 can be received over the connection 127 from the host system 120 via a vendor specific function 171 of an input output circuit 163 of the memory sub-system 110.

At block 309, the method includes identifying, based at least in part on the statistics (and the application context 157), a second ratio 155 between the capacity of the read buffer and the capacity of the write buffer.

For example, the method can further include: configuring, in the memory sub-system 110, a predictive model (e.g., artificial neural network model 207, lookup table 237); and providing, as an input to the predictive model, the new application context 157 that is based at least in part on the statistics to obtain the second ratio 155.

For example, the host system 120 can use the vendor specific function 171 to configure the firmware of the core logic 169 to include the predictive model.

At block 311, the method includes adjusting, in the local memory 117, the read buffer 141 and the write buffer 143 to have the second ratio 155 during a second time period following the first time period.

The predictive model can be configured to select the second ratio 155 that improves the likelihood of the memory sub-system 110 having an optimized performance during the second time period.

For example, the method can further include: training the predictive model (e.g., artificial neural network model 207) using a training dataset 202 configured to identify a plurality of application contexts (e.g., 221, . . . , 223) and a plurality of buffer ratios (e.g., 222, . . . , 224) previously determined for optimization of the performance of the memory sub-system 110 for the plurality of application contexts (e.g., 221, . . . , 223) respectively.

For example, the method can further include the determination or selection of a first optimized buffer ratio 205 for a first application context 203 for the training dataset 202. For example, after collecting activity data of the application running in a first application context 203 in the training dataset 202, a simulation or emulation of the application having the activity data can be performed during a time period following the application running in the first application context 203. During the simulation or emulation, different buffer ratios 211, . . . , 213 can be applied to measure the performance levels 212, . . . , 214 of the memory sub-system 110 having the read buffer and the write buffer configured according to the different buffer ratios 211, . . . , 213 respectively. From the performance test 201, the first optimized buffer ratio 205 can be selected for the first application context 203 such that the selected ratio 205 is most likely to optimize the performance level of the memory sub-system 110, according to the performance test 201, during the next period of time following the operations in the application context 203.

For example, the simulation or emulation can be performed in the host system 120 via the buffer manager 125. Alternatively, the activity data can be uploaded to a remote server to perform the simulation or emulation.

For example, the machine learning 209 of the artificial neural network model 207 from the training dataset 202 can be implemented in the host system 120 via the buffer manager 125. Alternatively, the training dataset 202 can be uploaded to a remote server to perform the machine learning 209.

Optionally, an artificial neural network model 207 trained via machine learning 209 from the training dataset 202 can be used to generate a lookup table 237 usable as the predictive model implemented in the buffer manager 115 in the memory sub-system 110. For example, a plurality of predetermined application contexts 231, . . . , 233 can be provided as inputs to the artificial neural network model 207 to obtain the respective ratios 232, . . . , 234. A current application context 225 can be rounded up to a closest context among the plurality of predetermined application contexts 231, . . . , 233; and the ratio specified for the closest context can be looked up from the table 237 and used as the predicted ratio 227 for the second period of time.

Optionally, the lookup table 237 can be generated directly from performance tests (e.g., 201) for the plurality of predetermined application contexts 231, . . . , 233 respectively, without using the machine learning 209 and the artificial neural network model 207.

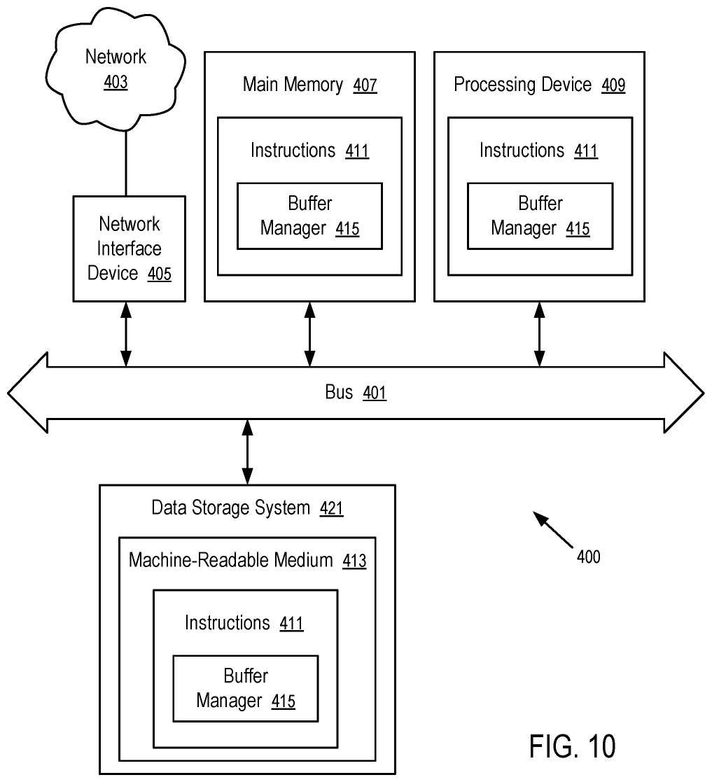

FIG. 10 is a block diagram of an example computer system in which embodiments of the present disclosure can operate.

FIG. 10 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory sub-system (e.g., the memory sub-system 110 of FIG. 1) or can be used to perform the operations of a buffer manager 415 (e.g., to execute instructions to perform operations corresponding to the buffer manager 115 and/or the buffer manager 125 described with reference to FIGS. 1-9). In alternative embodiments, the machine can be connected (e.g., networked) to other machines in a LAN, an intranet, an extranet, and/or the internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 409, a main memory 407 (e.g., read-only memory (ROM), flash memory, dynamic random-access memory (DRAM) such as synchronous DRAM (SDRAM) or Rambus DRAM (RDRAM), static random-access memory (SRAM), etc.), and a data storage system 421, which communicate with each other via a bus 401 (which can include multiple buses).

Processing device 409 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 409 can also be one or more special-purpose processing devices such as an application specific integrated circuit (ASIC), a field programmable gate array (FPGA), a digital signal processor (DSP), network processor, or the like. The processing device 409 is configured to execute instructions 411 for performing the operations and steps discussed herein. The computer system 400 can further include a network interface device 405 to communicate over the network 403.

The data storage system 421 can include a machine-readable medium 413 (also known as a computer-readable medium) on which is stored one or more sets of instructions 411 or software embodying any one or more of the methodologies or functions described herein. The instructions 411 can also reside, completely or at least partially, within the main memory 407 and/or within the processing device 409 during execution thereof by the computer system 400, the main memory 407 and the processing device 409 also constituting machine-readable storage media. The machine-readable medium 413, data storage system 421, and/or main memory 407 can correspond to the memory sub-system 110 of FIG. 1.

In one embodiment, the instructions 411 include instructions to implement functionality corresponding to a buffer manager 415 (e.g., the buffer manager 115 and/or the buffer manager 125 described with reference to FIGS. 1-9). While the machine-readable medium 413 is shown in an example embodiment to be a single medium, the term “machine-readable medium” should be taken to include a single medium or multiple media that store the one or more sets of instructions. The term “machine-readable medium” shall also be taken to include any medium that is capable of storing or encoding a set of instructions for execution by the machine and that cause the machine to perform any one or more of the methodologies of the present disclosure. The term “machine-readable medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random-access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random-access memory (“RAM”), magnetic disk storage media, optical storage media, flash memory devices, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special-purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
configuring, in a local memory of a memory sub-system, a read buffer and a write buffer having a first ratio between a capacity of the read buffer and a capacity of the write buffer;
buffering, in the read buffer, data communicated between the memory sub-system and a host system in association with read commands from the host system;
buffering, in the write buffer, data communicated between the memory sub-system and the host system in association with write commands from the host system;
determining statistics of read commands and write commands received in the memory sub-system during a first time period;
identifying, based at least in part on the statistics, a second ratio between the capacity of the read buffer and the capacity of the write buffer; and
adjusting, in the local memory, the read buffer and the write buffer to have the second ratio during a second time period following the first time period.

2. The method of claim 1, further comprising:
configuring, in the memory sub-system, a predictive model; and
providing, as an input to the predictive model, an application context based at least in part on the statistics to obtain the second ratio.

3. The method of claim 2, wherein the application context includes an identification of an application running in the host system to access the memory sub-system, a milestone of execution of the application, and a lapse time from the milestone.

4. The method of claim 3, further comprising:
receiving, from the host system, at least a portion of the application context.

5. The method of claim 4, wherein the receiving of the portion of the application context from the host system is via a vendor specific function of an input output circuit of the memory sub-system.

6. The method of claim 4, wherein the predictive model includes an artificial neural network model.

7. The method of claim 6, further comprising:
training the predictive model using a training dataset configured to identify a plurality of application contexts and a plurality of optimized buffer ratios determined for the plurality of application contexts respectively.

8. The method of claim 7, further comprising:
collecting activity data of the application running in a first application context in the training dataset;
performing a simulation or emulation of the application having the activity data during a time period following the application running in the first application context;
applying different buffer ratios in the simulation or emulation to measure performance levels of the memory sub-system configured according to the different buffer ratios respectively; and
determining a first optimized buffer ratio for the first application context from the performance levels measured for the different buffer ratios respectively.

9. The method of claim 2, wherein the predictive model includes a lookup table configured to map a plurality of predetermined application contexts to a plurality of buffer ratios.

10. The method of claim 9, further comprising:
mapping the application context to a closest context in the plurality of predetermined application contexts; and
determining the second ratio from the lookup table using the closest context.

11. An apparatus, comprising:
a memory sub-system having:
memory cells configured to provide a storage capacity of the memory sub-system;
a host interface operable to receive read commands and write commands from a host system;
a logic circuit; and
a local memory configured between the host interface and the logic circuit to buffer data communicated between the memory sub-system and the host system in association with the read commands and the write commands;
wherein the logic circuit is configured to:
identify a current application context of operating the memory sub-system; and
adjust, in the local memory, a ratio of a read buffer and a write buffer allocated from the local memory according to the current application context for communications with the host system during a next period of time.

12. The apparatus of claim 11, wherein the logic circuit is configured to compute an optimized ratio predicted via a predictive model and allocate the read buffer and the write buffer for the next period of time based on the optimized ratio predicted via the predictive model.

13. The apparatus of claim 12, wherein the predictive model is implemented via a lookup table stored in the memory sub-system; and the application context includes a ratio of read commands and write commands received from the host system during a previous period of time.

14. The apparatus of claim 13, wherein the memory sub-system includes a universal flash storage (UFS) device; and the host interface includes an input output circuit configured to perform data communications according to an M-PHY protocol.

15. The apparatus of claim 14, further comprising:
the host system connected to the host interface and configured to provide at least a portion of the application context via a vendor specific function of the input output circuit.

16. The apparatus of claim 14, further comprising:
the host system connected to the host interface to configure the predictive model implemented in the memory sub-system via the logic circuit.

17. A non-transitory computer storage medium storing instructions which, when executed in a computing system having a host system connected to a memory sub-system, causes the computing system to perform a method, the method comprising:
determining a current application context of operating the memory sub-system; and
adjusting, according to the current application context for communications between the host system and the memory sub-system during a next period of time, a ratio of allocating a read buffer and a write buffer in the memory sub-system.

18. The non-transitory computer storage medium of claim 17, wherein the method further comprises:
measuring performance levels of the memory sub-system in a time period following the memory sub-system being operated at a first application context while the read buffer and the write buffer in the memory sub-system are configured according to a plurality of test ratios; and
determining, from the performance levels measured for the test ratios respectively, a first ratio selected to configure the read buffer and the write buffer during a time period following the memory sub-system being operated at the first application context.

19. The non-transitory computer storage medium of claim 18, wherein the method further comprises:
training a predictive model using a training dataset having a plurality of application contexts and a plurality of selected ratios, the plurality of application contexts including the first application context, and the plurality of selected ratios including the first ratio selected for the first application context.

20. The non-transitory computer storage medium of claim 19, wherein the method further comprises:
generating a lookup table of buffer ratios for a set of predetermined application contexts using the predictive model; and
configuring the memory sub-system according to the ratio of allocating the read buffer and the write buffer using the lookup table.
